(19) United States
(12) Patent Application Publication
(10) Pub. No.: US 2026/0018103 A1
(43) Pub. Date: Jan. 15, 2026

(54) DRIVER CIRCUIT AND DISPLAY DEVICE

(71) Applicant: Sharp Display Technology Corporation, Kameyama City (JP)

(72) Inventors: Seiya KAWAMORITA, Kameyama City (JP); Yasuaki IWASE, Kameyama City (JP); Shinji MATSUBARA, Kameyama City (JP)

(21) Appl. No.: 19/263,178

(22) Filed: Jul. 8, 2025

(30) Foreign Application Priority Data
Jul. 9, 2024 (JP) 2024-110454

(51) Int. Cl. G09G 3/20

(52) U.S. Cl. CPC G09G 3/2092; G09G 2310/0267; G09G 2310/08; G09G 2330/021

(57) ABSTRACT

A driver circuit for driving a plurality of signal lines, the driver circuit includes a plurality of unit circuits including an nth unit circuit, wherein the nth unit circuit includes a clock terminal through which a clock signal is inputted, a setting terminal through which a setting signal is outputted to another unit circuit, a setting transistor connected to the clock terminal and the setting terminal, a control node, a control capacitor, and a control transistor whose gate terminal is connected to the control node, the control node is connected to a first conducting terminal of the control transistor via the control capacitor, and a second conducting terminal of the control transistor is connected to the clock terminal.

### BACKGROUND

### 1. Field

The present disclosure relates to a driver circuit.

### 2. Description of the Related Art

Japanese Unexamined Patent Application Publication No. 2011-209714 discloses a driver circuit for use in a display device that performs a partial display.

The known driver circuit is undesirably low in the accuracy of a setting signal that controls another unit circuit.

### SUMMARY

According to an aspect of the disclosure, there is provided a driver circuit for driving a plurality of signal lines. The driver circuit includes a plurality of unit circuits including an nth unit circuit. The nth unit circuit includes a clock terminal through which a clock signal is inputted, a setting terminal through which a setting signal is outputted to another unit circuit, a setting transistor connected to the clock terminal and the setting terminal, a control node, a control capacitor, and a control transistor whose gate terminal is connected to the control node. The control node is connected to a first conducting terminal of the control transistor via the control capacitor, and a second conducting terminal of the control transistor is connected to the clock terminal.

### BRIEF DESCRIPTION OF THE DRAWINGS

FIG. 1 is a schematic view showing a configuration of a driver circuit according to the present embodiment;

FIG. 2 is a timing chart showing operation of the driver circuit according to the present embodiment;

FIG. 3 is a circuit diagram showing a configuration of a unit circuit of the driver circuit according to the present embodiment;

FIG. 4 is a circuit diagram showing a configuration of a unit circuit of the driver circuit according to the present embodiment;

FIG. 5 is a circuit diagram showing a configuration of a unit circuit of the driver circuit according to the present embodiment;

FIG. 6 is a block diagram showing a configuration of a display device according to the present embodiment;

FIG. 7 is a schematic view showing a configuration of a driver circuit according to the present embodiment;

FIG. 8 is a circuit diagram showing a configuration of a unit circuit of the driver circuit according to the present embodiment;

FIG. 9 is a circuit diagram showing a configuration of a unit circuit of the driver circuit according to the present embodiment;

FIG. 10 is a circuit diagram showing a configuration of a unit circuit of the driver circuit according to the present embodiment; and

FIG. 11 is a timing chart showing operation of the driver circuit according to the present embodiment.

### DESCRIPTION OF THE EMBODIMENTS

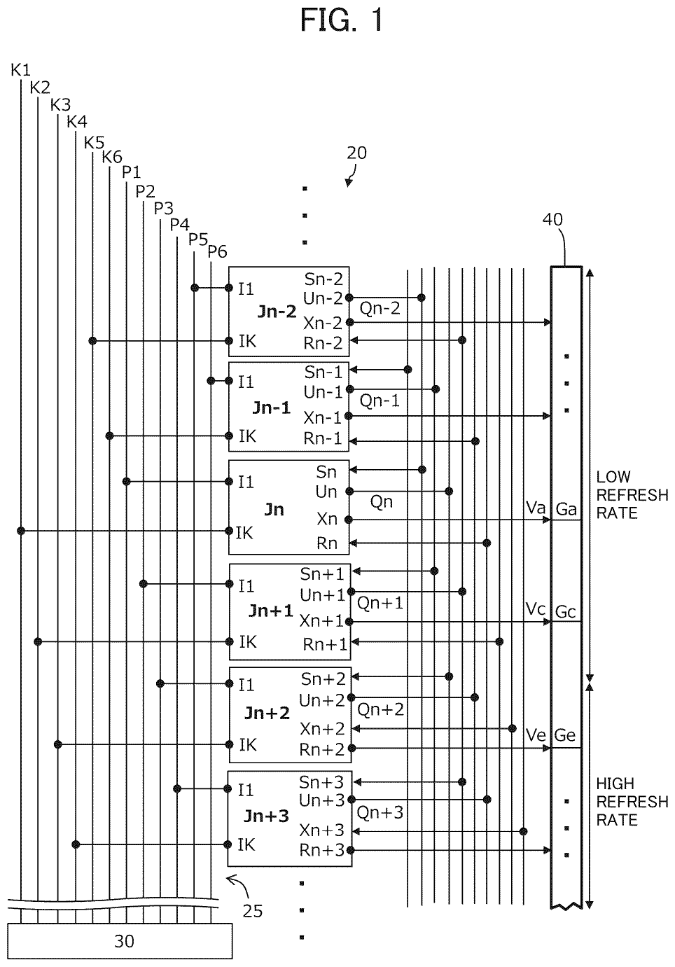

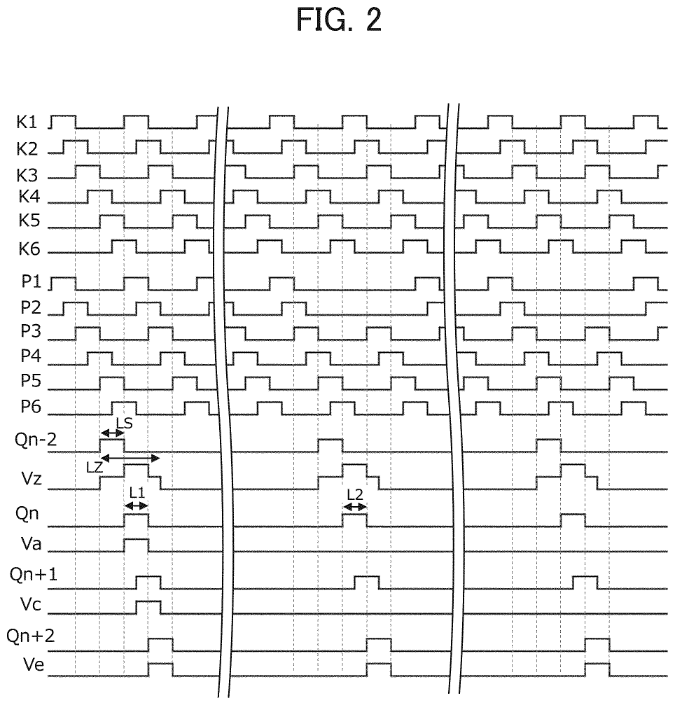

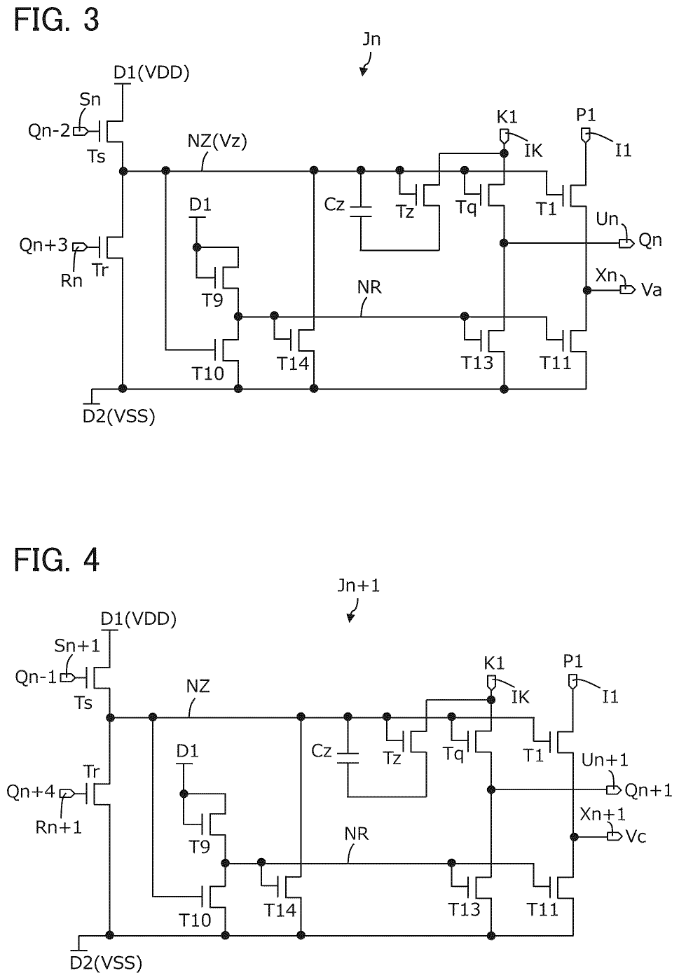

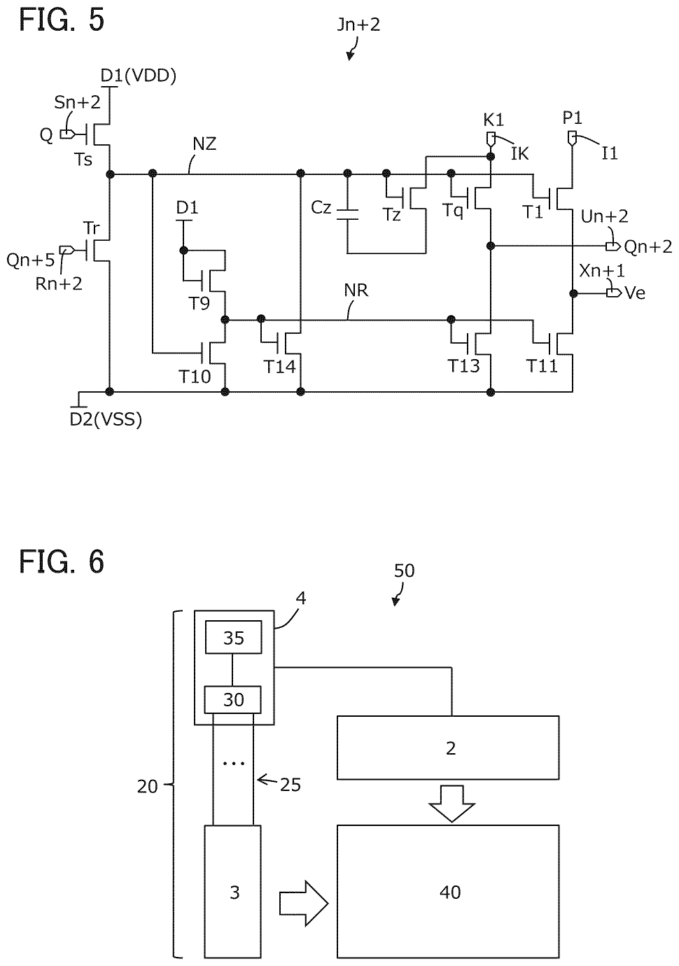

FIG. 1 is a schematic view showing a configuration of a driver circuit according to the present embodiment. FIG. 2 is a timing chart showing operation of the driver circuit according to the present embodiment. FIGS. 3 to 5 are circuit diagrams showing configurations of unit circuits of the driver circuit according to the present embodiment. As shown in FIGS. 1 to 5, a driver circuit 20 is a driver circuit for driving a plurality of signal lines (such as Ga to Gf) and includes a plurality of unit circuits (such as Jn, Jn−1, and Jn+1). The nth unit circuit Jn includes a clock terminal IK through which a clock signal K1 is inputted, a setting terminal Un through which a setting signal Qn is outputted to another unit circuit (such as Jn+2), a setting transistor Tq connected to the clock terminal IK and the setting terminal Un, a control node NZ, a control capacitor Cz, and a control transistor Tz whose gate terminal is connected to the control node NZ. The control node NZ is connected to a first conducting terminal of the control transistor Tz via the control capacitor Cz, and a second conducting terminal of the control transistor Tz is connected to the clock terminal IK. n is a natural number.

The setting terminal Un may be connected to the clock terminal IK via the setting transistor Tq. The setting signal Qn may have a function of setting a subsequent unit circuit. The setting signal Qn may have a function of resetting a preceding unit circuit. This causes the setting terminal Un to be less affected by noise generated in the control capacitor Cz by the clock signal K1 or other high-frequency signals, making it possible to generate the setting signal Qn with a high degree of accuracy.

The nth unit circuit Jn may have a first input terminal I1 through which a first pulse signal P1 is inputted, a first driving terminal Xn through which a first driving signal Va is outputted to one of the plurality of signal lines (including Ga to Gc), and a first transistor T1. The first driving terminal Xn may be connected to the first input terminal I1 via the first transistor T1. A gate terminal of the first transistor T1 may be connected to the control node NZ, and the gate terminal of the setting transistor Tq may be connected to the control node NZ.

As shown in FIG. 2, in the nth unit circuit Jn, in a set period LS (i.e. an active period of Qn−2), the control transistor Tz may be turned on and the control capacitor Cz may be charged by the control node NZ becoming active (High), and the control node NZ may be boosted by the clock signal K1 rising.

By the control node NZ being boosted by the control capacitor Cz, the driving capability of the setting transistor Tq is enhanced and the setting signal Qn is stabilized. That is, pulses of the clock signal K1 are stably outputted through the setting terminal Un. Furthermore, by the control node NZ being boosted by the control capacitor Cz, the driving capability of the first transistor T1 is enhanced and the first driving signal Va is stabilized. That is, pulses of the first pulse signal P1 are stably outputted through the first driving terminal Xn.

The driver circuit 20 may include a first power supply line D1 (e.g. a high-potential-side power supply line or a VDD line) and a second power supply line D2 (e.g. a low-potential-side power supply line or a VSS line). The nth unit circuit Jn may have a set transistor Ts to which a set signal (Qn−2) from a preceding unit circuit is inputted and a reset transistor Tr through which a reset signal (Qn+3) from a subsequent unit circuit is inputted. The control node NZ may be connected to the first power supply line D1 via the set transistor Ts and connected to the second power supply line D2 via the reset transistor Tr. As a result of this, the control node NZ is made active (i.e. the nth unit circuit Jn is set) by the set signal Qn−2 rising, and the control node NZ is made non-active (i.e. the nth unit circuit Jn is reset) by the reset signal Qn+3 rising.

In the nth unit circuit Jn, the setting signal Qn is active (High) during a first period L1, and the first period L1 may overlap at least part of an active period (High period) of the first driving signal Va. An active period of the setting signal Qn and the active period of the first driving signal Va may substantially coincide with each other. The setting signal Qn may be active during a second period L2, and the first driving signal Va may be non-active during the second period L2.

The setting signal Qn may function as a set signal, and another unit circuit (Jn+2) may be set during the first period L1 and the second period L2. The setting signal Qn may be active during the second period L2, and the number of pulses in the first pulse signal P1 during the second period L2 may be reduced.

The first power supply line D1 may be a high-potential-side power supply line, and the second power supply line D2 may be a low-potential-side power supply line The nth unit circuit Jn may have an inverting node NR that is put in the opposite state to the control node NZ and a plurality of pull-down transistors T11, T13, and T14 whose gate terminals are connected to the inverting node NR. The setting terminal Un and the control node NZ may be connected to the second power supply line D2 via different pull-down transistors. That is, the setting terminal Un may be connected to the second power supply line D2 via the pull-down transistor T13, and the control node NZ may be connected to the second power supply line D2 via the pull-down transistor T14. The first driving terminal Xn may be connected to the second power supply line D2 via the pull-down transistor T11.

In this way, while the pull-down transistors T13 and T14 are turned off in the period LZ, during which the control node NZ is active (High), the control node NZ becomes non-active (Low) (that is, the inverting node NR becomes active High), whereby the setting transistor Tq is turned off and the pull-down transistors T13 and T14 are turned on. This causes the potentials of the setting terminal Un and the control node NZ to be maintained at a Low level regardless of the level of the clock signal K1 and causes the setting signal Qn to be maintained as non-active (Low).

Further, while the pull-down transistor T11 is turned off in the period LZ, during which the control node NZ is active (High), the control node NZ becomes non-active (Low) (that is, the inverting node NR becomes active High), whereby the first transistor T1 is turned off and the pull-down transistor T11 is turned on. This causes the potential of the first driving terminal Xn to be maintained at a Low level regardless of the level of the first pulse signal P1 and causes the first driving signal Va to be maintained as non-active (Low).

In the nth unit circuit Jn, the inverting node NR may be connected to the first power supply line D1 (high-potential-side power supply line) via a diode-connected transistor T9 (power supply line transistor) and connected to the second power supply line D2 (low-potential-side power supply line) via a transistor T10 (inverting transistor), and a gate terminal of the transistor T10 may be connected to the control node NZ. The transistors T9 to T11, T13, and T14 may constitute an inverting circuit.

As shown in FIG. 1, the driver circuit 20 may include a signal generation circuit 30 that generates the clock signals K1 to K6 and the first to sixth pulse signals P1 to P6 and an input line group 25 through which the clock signals K1 to K6 and the first to sixth pulse signals P1 to P6 are transmitted.

Although, in FIGS. 3 to 5, the setting transistor Tq, the control transistor Tz, the set transistor Ts, the reset transistor Tr, the pull-down transistors T13 and T14, and the transistors T9 and T10 may be n-channel transistors, this is not intended to impose any limitation. These transistors may be constituted by p-channel transistors, or these transistors may be constituted by n-channel transistors and p-channel transistors.

FIG. 6 is a block diagram showing a configuration of a display device according to the present embodiment. As shown in FIG. 6, a display device 50 according to the present embodiment may include the display unit 40, a data driver 2, a scan driver 3, and a controller 4. The display unit 40 may be capable of setting refresh rates on an area-by-area basis. The driver circuit 20 may include the scan driver 3 (shift register circuit), the controller 4, and the input line group 25. The controller 4 may include the signal generation circuit 30 and a processor 35. The controller 4 may be a timing controller.

In the display device 50, the display unit 40 may have a plurality of liquid crystal capacitors (including a pixel electrode, a counter electrode, and a liquid crystal layer). In the display device 50, the display unit 40 may have a plurality of light-emitting elements (e.g. organic light-emitting diodes and quantum dot light-emitting diodes), and the driver circuit 20 may include at least either a scan driver or a light emission control driver.

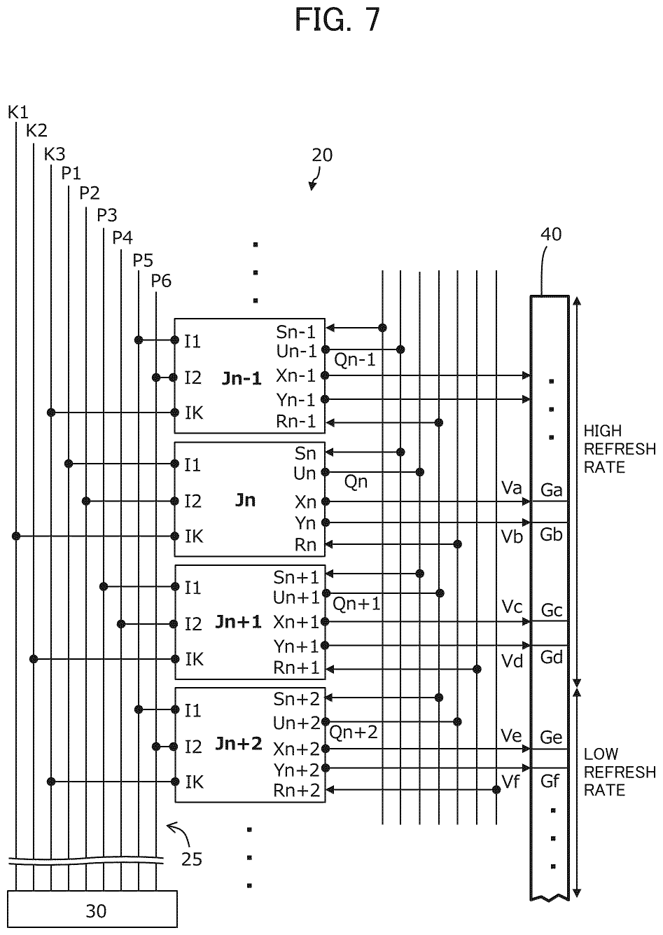

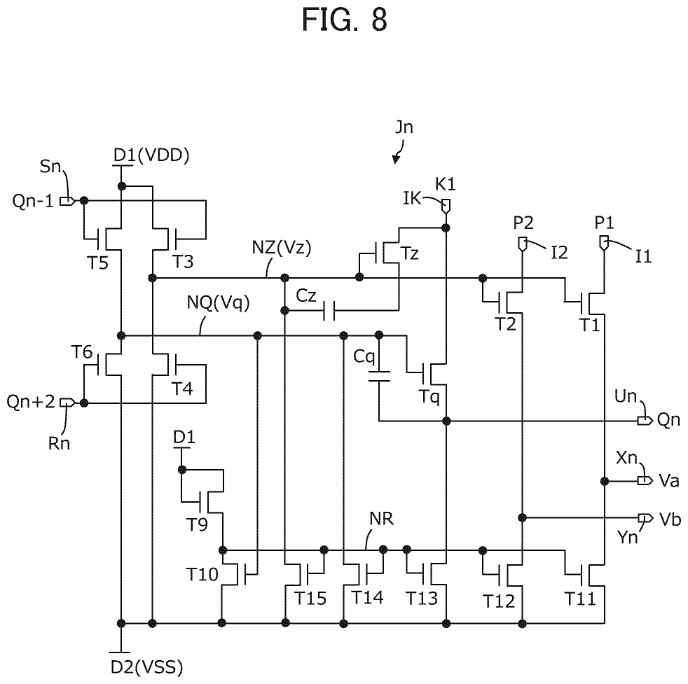

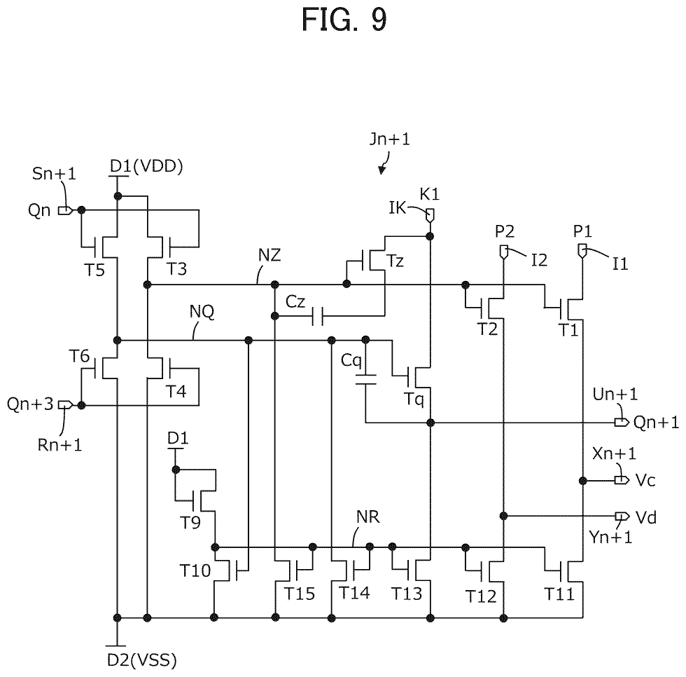

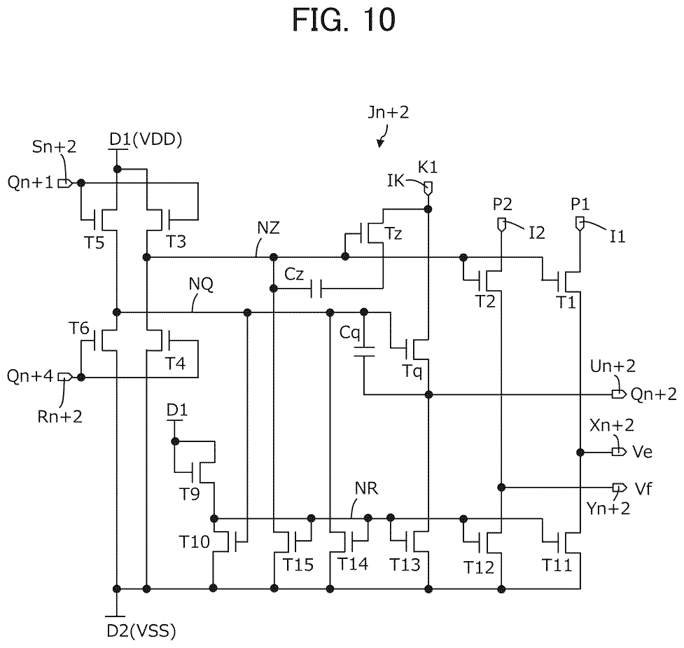

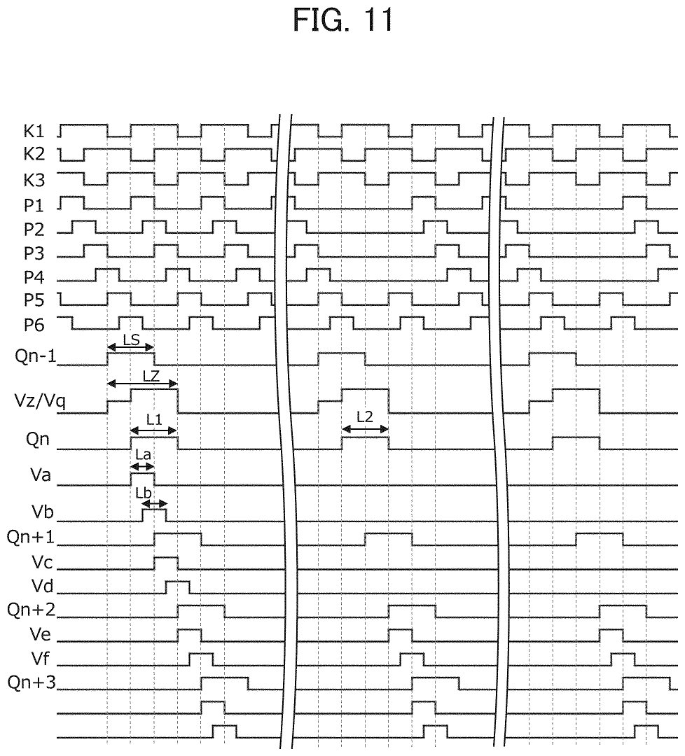

FIG. 7 is a schematic view showing a configuration of a driver circuit according to the present embodiment. FIGS. 8 to 10 are circuit diagrams showing configurations of unit circuits of the driver circuit according to the present embodiment. FIG. 11 is a timing chart showing operation of the driver circuit according to the present embodiment. As shown in FIGS. 8 to 10, the nth unit circuit Jn may have, in addition to the first input terminal I1 and the first driving terminal Xn, a second input terminal 12 through which a second pulse signal P2 is inputted, a second driving terminal Yn through which a second driving signal Vb is outputted to another one (Gb) of the plurality of signal lines, and a second transistor T2. The second driving terminal Yn may be connected to the second input terminal 12 via the second transistor T2, and a gate terminal of the second transistor T2 may be connected to the control node NZ.

This causes the setting terminal Un to be less affected by noise generated in the control capacitor Cz by high-frequency signals (such as K1, P1, and P2), making it possible to generate the setting signal Qn with a high degree of accuracy.

The nth unit circuit Jn may have a setting node NQ that becomes active in the set period LS and a bootstrap capacitor Cq. The setting terminal Un may be connected to the setting node NQ via the bootstrap capacitor Cq.

The nth unit circuit Jn may have third and fifth transistors T3 and T5 (set transistors) to which a set signal (e.g. Qn−1) from a preceding unit circuit is inputted through gate terminals (set terminals Sn) thereof and fourth and sixth transistors T4 and T6 (reset transistors) to which a reset signal (e.g. Qn+2) from a subsequent unit circuit is inputted through gate terminals (reset terminals Rn) thereof.

The control node NZ may be connected to the first power supply line D1 via the third transistor T3 and connected to the second power supply line D2 via the fourth transistor T4. The setting node NQ may be connected to the first power supply line D1 via the fifth transistor T5 and connected to the second power supply line D2 via the sixth transistor T6. As a result of this, the control node NZ and the setting node NQ are made active by the set signal Qn−1 rising, and the control node NZ and the setting node NQ are made non-active by the reset signal Qn+2 rising.

In the driver circuit 20 shown in FIGS. 7 to 11, the setting signal Qn is active during the first period L1, and the first period L1 includes at least part of an active period La of the first driving signal Va and at least part of an active period Lb of the second driving signal Vb. The first period L1 may include all of the active period La of the first driving signal Va and all of the active period Lb of the second driving signal Vb. The first period L1 may include all of the active period La of the first driving signal Va and part of the active period Lb of the second driving signal Vb.

In the driver circuit 20, the two signal lines Ga and Gb can be driven by the first second driving signals Va and Vb generated in the nth unit circuit Jn. This causes the driver circuit 20 to have a decreased circuit size.

The plurality of signal lines Ga to Gf may be scanning lines, and the first and second driving signals Va and Vb may be scan signals (scanning signals). The signal line Ga may be the (2n−1)th scanning line formed in a display unit 40, and the signal line Gb may be the (2n)th scanning line formed in the display unit 40.

A period LZ during which the setting node NQ stays active (High) may include the active period La of the first driving signal Va and the active period Lb of the second driving signal Vb. The control node NZ is at a potential Vz, and the setting node NQ is at a potential Vq.

In the driver circuit 20, the setting signal Qn may be active during a second period L2, and the first and second driving signals Va and Vb may be non-active during the second period L2. That is, total scanning by which all of the plurality of signal lines (including Ga to Gf) are scanned and partial scanning by which only some of the plurality of signal lines (including Ge and Gf) are scanned may be performed. The setting signal Qn may function as a set signal, and another unit circuit (Jn+2) may be set during the first period L1 and the second period L2. This makes it possible to vary refresh rates (frequencies of rewriting) from one area to another in the display unit 40 (including the signal lines Ga to Gf) that is to be driven, making it possible to reduce power consumption.

In the examples shown in FIGS. 7 to 11, an area including the signal lines (scanning lines) Ga to Gd is refreshed at a low refresh rate, and an area including the signal lines (scanning lines) Ge and Gf is refreshed at a high refresh rate. A still image may be displayed in the low-refresh-rate area, and a moving image may be displayed in the high-refresh-rate area.

As shown in FIG. 11, in the driver circuit 20, the first and second driving signals Va and Vb may become active (rise from Low to High) in sequence within the first period L1 (i.e. the active period of the setting signal Qn). Part (e.g. the second half) of the active period La of the first driving signal Va and part (e.g. the first half) of the active period Lb of the second driving signal Vb may overlap each other. The first and second driving signals Va and Vb may return (from active High) to non-active in the first period L1.

As shown in FIG. 11, in the first period L1, the first and second pulse signals P1 and P2 may become active in sequence while the clock signal K1 stays active. Although, in FIG. 11, the first and second pulse signals P1 and P2 are equal in pulse width to each other and different in phase from each other and the pulse width of the clock signal K1 is a natural number multiple of (e.g. twice as great as) the pulse width of the first and second pulse signals P1 and P2, this is not intended to impose any limitation. Further, although a timing at which the clock signal K1 becomes active (rises) and a timing at which the first pulse signal P1 becomes active (rises) are in synchronization with each other, this is not intended to impose any limitation.

The phase shift between the first and second pulse signals P1 and P2 may be equivalent to one horizontal scanning period. The clock signal K1 and the first and second pulse signals P1 and P2 may be made equal in periodicity to each other. In FIG. 11, for example, the clock signal K1 is active for 4H out of 6H periodicity, and the first and second pulse signals P1 and P2 are active for 2H out of 6H periodicity. 1H is one horizontal scanning period.

As shown in FIG. 11, the setting signal Qn may be active during the second period L2, and the numbers of pulses in the first and second pulse signals P1 and P2 during the second period L2 may be reduced.

To the driver circuit 20, a clock signal group (K1 to K3) of two or more phases including the clock signal K1 and a pulse signal group (P1 to P6) of three or more phases including the first and second pulse signals P1 and P2 may be inputted. The number of phases of the clock signal group (in FIG. 11, the three phases K1 to K3) may be smaller than the number of phases of the pulse signal group (in FIG. 11, the six phases P1 to P6).

The nth unit circuit Jn shown in FIG. 11 has, in addition to the control node NZ, a setting node NQ that becomes active in the set period LS, and the setting terminal Un is connected to the setting node NQ via the bootstrap capacitor Cq. In this case, in the set period LS, the setting transistor Tq may be turned on and the bootstrap capacitor Cq may be charged by the setting node NQ becoming active (high), and the setting node NQ may be boosted by the clock signal K1 rising. This enhances the driving capability of the setting transistor Tq and stabilizes the setting signal Qn. That is, pulses of the clock signal K1 are stably outputted through the setting terminal Un.

Providing the setting node NQ in addition to the control node NZ makes it possible to reduce a load on the control node NZ and substantially remove the influence of the first and second pulse signals P1 and P2 on the setting node NQ. This makes it possible to further stabilize the setting signal Qn.

The nth unit circuit Jn may have an inverting node NR that is put in the opposite state to the setting node NQ and a plurality of pull-down transistors T11 to T15 whose gate terminals are connected to the inverting node NR. The setting terminal Un, the control node NZ, and the setting node NQ may be connected to the second power supply line D2 via different pull-down transistors. That is, the setting terminal Un may be connected to the second power supply line D2 via the pull-down transistor T13. The setting node NQ may be connected to the second power supply line D2 via the pull-down transistor T14. The control node NZ may be connected to the second power supply line D2 via the pull-down transistor T15. The first driving terminal Xn may be connected to the second power supply line D2 via the pull-down transistor T11, and the second driving terminal Yn may be connected to the second power supply line D2 via the pull-down transistor T12.

In this way, while the pull-down transistors T11 to T15 are turned off in a period during which the setting node NQ is active (High), the setting node NQ becomes non-active (Low) (that is, the inverting node NR becomes active High), whereby the setting transistor Tq is turned off and the pull-down transistors T11 to T15 are turned on. This causes the potentials of the setting terminal Un, the control node NZ, and the setting node NQ to be maintained at a Low level regardless of the levels of the clock signal K1 and the first and second pulse signals P1 and P2 and causes the setting signal Qn and the first and second driving signals Va and Vb to be maintained as non-active (Low).

In the nth unit circuit Jn, the inverting node NR may be connected to the first power supply line D1 (high-potential-side power supply line) via a diode-connected transistor T9 (power supply line transistor) and connected to the second power supply line D2 (low-potential-side power supply line) via a transistor T10 (inverting transistor), and a gate terminal of the transistor T10 may be connected to the setting node NQ. The transistors T9 to T15 may constitute an inverting circuit.

Each of the aforementioned embodiments is for illustrative and explanatory purposes and not for limitative purposes. Based on these illustrations and explanations, it is obvious to persons skilled in the art that many modifications become possible.

The following describes the conclusion of the present embodiment. The term “aforementioned” hereinafter encompasses technical contents disclosed at least one of FIGS. 1 to 11.

A driver circuit for driving a plurality of signal lines includes a plurality of unit circuits including an nth unit circuit. The nth unit circuit includes a clock terminal through which a clock signal is inputted, a setting terminal through which a setting signal is outputted to another unit circuit, a setting transistor connected to the clock terminal and the setting terminal, a control node, a control capacitor, and a control transistor whose gate terminal is connected to the control node. The control node is connected to a first conducting terminal of the control transistor via the control capacitor, and a second conducting terminal of the control transistor is connected to the clock terminal.

In the aforementioned driver circuit, the nth unit circuit may have a first input terminal through which a first pulse signal is inputted, a first driving terminal through which a first driving signal is outputted to one of the plurality of signal lines, and a first transistor, and the first driving terminal may be connected to the first input terminal via the first transistor.

In the aforementioned driver circuit, a gate terminal of the first transistor may be connected to the control node.

In the aforementioned driver circuit, a gate terminal of the setting transistor may be connected to the control node.

In the aforementioned driver circuit, in a set period, the setting transistor may be turned on and the control capacitor may be charged by the control node becoming active, and the control node is boosted by the clock signal rising.

The aforementioned driver circuit may further include a first power supply line and a second power supply line. The nth unit circuit may have a set transistor to which a set signal from a preceding unit circuit is inputted and a reset transistor to which a reset signal from a subsequent unit circuit is inputted, and the control node may be connected to the first power supply line via the set transistor and connected to the second power supply line via the reset transistor.

In the aforementioned driver circuit, the setting signal may be active during a first period, and the first period may overlap at least part of an active period of the first driving signal.

In the aforementioned driver circuit, the setting signal may be active during a second period, and the first driving signal may be non-active during the second period.

In the aforementioned driver circuit, the setting signal may function as a set signal, and another unit circuit may be set during the first period and the second period.

In the aforementioned driver circuit, the setting signal may be active during the second period, and the number of pulses in the first pulse signal during the second period may be reduced.

In the aforementioned driver circuit, the first power supply line may be a high-potential-side power supply line. The second power supply line may be a low-potential-side power supply line. The nth unit circuit may have an inverting node that is put in an opposite state to the control node and a plurality of pull-down transistors whose gate terminals are connected to the inverting node. The setting terminal and the control node may be connected to the second power supply line via different pull-down transistors.

In the aforementioned driver circuit, the first driving terminal may be connected to the second power supply line via a pull-down transistor.

In the aforementioned driver circuit, the plurality of signal lines may be scanning lines, and the first driving signal may be a scan signal.

In the aforementioned driver circuit, the plurality of signal lines may be formed in a display unit that is capable of setting refresh rates on an area-by-area basis.

In the aforementioned driver circuit, total scanning by which all of the plurality of signal lines are scanned and partial scanning by which some of the plurality of signal lines are scanned may be performed.

In the aforementioned driver circuit, the nth unit circuit may have a second input terminal through which a second pulse signal is inputted, a second driving terminal through which a second driving signal is outputted to another one of the plurality of signal lines, and a second transistor. The second driving terminal may be connected to the second input terminal via the second transistor. A gate terminal of the second transistor may be connected to the control node.

In the aforementioned driver circuit, the nth unit circuit may have a setting node that becomes active in a set period and a bootstrap capacitor. A gate terminal of the setting transistor may be connected to the setting node. The setting terminal may be connected to the setting node via the bootstrap capacitor.

In the aforementioned driver circuit, an active period of the setting signal may include an active period of the first driving signal and an active period of the second driving signal.

In the aforementioned driver circuit, the first and second driving signals become active in sequence in an active period of the setting signal.

In the aforementioned driver circuit, part of an active period of the first driving signal and part of an active period of the second driving signal may overlap each other.

In the aforementioned driver circuit, the first and second driving signals may return to non-active in an active period of the setting signal.

In the aforementioned driver circuit, in an active period of the setting signal, the first and second pulse signals may become active in sequence while the clock signal stays active.

In the aforementioned driver circuit, the first and second pulse signals may be equal in pulse width to each other and different in phase from each other, and the pulse width of the clock signal may be a natural number multiple of the pulse width of the first and second pulse signals.

In the aforementioned driver circuit, a timing at which the clock signal becomes active and a timing at which the first pulse signal becomes active may be in synchronization with each other.

In the aforementioned driver circuit, a phase shift between the first and second pulse signals may be equivalent to one horizontal scanning period.

In the aforementioned driver circuit, a clock signal group of two or more phases including the clock signal and a pulse signal group of three or more phases including the first and second pulse signals may be inputted.

In the aforementioned driver circuit, the number of phases of the clock signal group may be smaller than the number of phases of the pulse signal group.

The aforementioned driver circuit may further include a first power supply line and a second power supply line. The nth unit circuit may have third and fifth transistors to which a set signal from a preceding unit circuit is inputted and fourth and sixth transistors to which a reset signal from a subsequent unit circuit is inputted. The control node may be connected to the first power supply line via the third transistor and connected to the second power supply line via the fourth transistor. The setting node may be connected to the first power supply line via the fifth transistor and connected to the second power supply line via the sixth transistor.

The aforementioned driver circuit may further include a signal generation circuit that generates the clock signal and the first and second pulse signals and an input line group through which the clock signal and the first and second pulse signals are transmitted.

A display device includes the aforementioned driver circuit.

The aforementioned display device may further include a display unit that is capable of setting refresh rates on an area-by-area basis.

The present disclosure contains subject matter related to that disclosed in Japanese Priority Patent Application JP 2024-110454 filed in the Japan Patent Office on Jul. 9, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A driver circuit for driving a plurality of signal lines, the driver circuit comprising a plurality of unit circuits including an nth unit circuit,
wherein
the nth unit circuit includes a clock terminal through which a clock signal is inputted, a setting terminal through which a setting signal is outputted to another unit circuit, a setting transistor connected to the clock terminal and the setting terminal, a control node, a control capacitor, and a control transistor whose gate terminal is connected to the control node,
the control node is connected to a first conducting terminal of the control transistor via the control capacitor, and
a second conducting terminal of the control transistor is connected to the clock terminal.

2. The driver circuit according to claim 1, wherein
the nth unit circuit has a first input terminal through which a first pulse signal is inputted, a first driving terminal through which a first driving signal is outputted to one of the plurality of signal lines, and a first transistor, and
the first driving terminal is connected to the first input terminal via the first transistor.

3. The driver circuit according to claim 2, wherein a gate terminal of the first transistor is connected to the control node.

4. The driver circuit according to claim 1, wherein a gate terminal of the setting transistor is connected to the control node.

5. The driver circuit according to claim 1, wherein in a set period, the setting transistor is turned on and the control capacitor is charged by the control node becoming active, and the control node is boosted by the clock signal rising.

6. The driver circuit according to claim 2, further comprising:
a first power supply line; and
a second power supply line,
wherein
the nth unit circuit has a set transistor to which a set signal from a preceding unit circuit is inputted and a reset transistor to which a reset signal from a subsequent unit circuit is inputted, and
the control node is connected to the first power supply line via the set transistor and connected to the second power supply line via the reset transistor.

7. The driver circuit according to claim 2, wherein
the setting signal is active during a first period, and
the first period overlaps at least part of an active period of the first driving signal.

8. The driver circuit according to claim 7, wherein
the setting signal is active during a second period, and
the first driving signal is non-active during the second period.

9. The driver circuit according to claim 8, wherein
the setting signal functions as a set signal, and
another unit circuit is set during the first period and the second period.

10. The driver circuit according to claim 8, wherein
the setting signal is active during the second period, and
the number of pulses in the first pulse signal during the second period is reduced.

11. The driver circuit according to claim 6, wherein
the first power supply line is a high-potential-side power supply line,
the second power supply line is a low-potential-side power supply line,
the nth unit circuit has an inverting node that is put in an opposite state to the control node and a plurality of pull-down transistors whose gate terminals are connected to the inverting node, and
the setting terminal and the control node are connected to the second power supply line via different pull-down transistors.

12. The driver circuit according to claim 11, wherein the first driving terminal is connected to the second power supply line via a pull-down transistor.

13. The driver circuit according to claim 2, wherein
the nth unit circuit has a second input terminal through which a second pulse signal is inputted, a second driving terminal through which a second driving signal is outputted to another one of the plurality of signal lines, and a second transistor,
the second driving terminal is connected to the second input terminal via the second transistor, and
a gate terminal of the second transistor is connected to the control node.

14. The driver circuit according to claim 13, wherein
the nth unit circuit has a setting node that becomes active in a set period and a bootstrap capacitor,
a gate terminal of the setting transistor is connected to the setting node, and
the setting terminal is connected to the setting node via the bootstrap capacitor.

15. The driver circuit according to claim 13, wherein an active period of the setting signal includes an active period of the first driving signal and an active period of the second driving signal.

16. The driver circuit according to claim 13, wherein the first and second driving signals become active in sequence in an active period of the setting signal.

17. The driver circuit according to claim 13, wherein part of an active period of the first driving signal and part of an active period of the second driving signal overlap each other.

18. The driver circuit according to claim 13, wherein the first and second driving signals return to non-active in an active period of the setting signal.

19. The driver circuit according to claim 13, wherein in an active period of the setting signal, the first and second pulse signals become active in sequence while the clock signal stays active.

20. A display device comprising:
the driver circuit according to claim 1, and
a display unit that is capable of setting refresh rates on an area-by-area basis,
wherein
the plurality of signal lines are scanning lines,
a first driving signal is a scan signal, and
the plurality of signal lines are formed in the display unit.
